(19) United States
(12) Patent Application Publication
(10) Pub. No.: US 2005/0030961 A1
(43) Pub. Date: Feb. 10, 2005

(54) Ring selection method for dual ring network

(76) Inventors: Kang-Bok Lee, Daejeon (KR); Heyung-Sub Lee, Daejeon (KR); Hyeong-Ho Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/696,131

(22) Filed: Oct. 28, 2003

(30) Foreign Application Priority Data
Nov. 18, 2002 (KR) 2002-71500

(51) Int. Cl. H04L 12/28; H04L 12/56

(52) U.S. Cl. 370/404; 370/401

(57) ABSTRACT

A ring selection method for a dual ring network to perform node-to-node packet transmission. A transmission node transmits a reception node address request message for packet transmission to all nodes, and updates a routing table using information on a short path transferred from the reception node. The information on inter-node hop numbers included in the routing table is used to select a ring having the lowest hop number between the reception nodes It is then determined whether the selected ring is wrapped, and if the ring is not wrapped, comparing its usage rate and hop number to the reception node with reference values based on a ring selection algorithm; and if the ring is suitable based on the reference values, selecting the ring for packet transmission.

### BACKGROUND OF THE INVENTION

(a) Field of the Invention

The present invention relates to a ring selection method for dual ring networks. More specifically, the present invention relates to a ring selection method for dual ring networks that enables simultaneous data transmission of two rings in dual ring networks using a spatial reuse protocol.

(b) Description of the Related Art

There are different systems using a ring network structure, among which the token ring system is the earliest ring network.

The token ring system is designed to transmit data only by a node with a received frame called a token. But the token ring system is problematic in that the node is allowed to access the system only upon receiving the token, and it must be in a stand-by mode until the token is given.

Unlike the token ring system, FDDI (Fiber Distributed-Data Interface) employs a dual ring method.

In FDDI, one ring is used for data transmission, and the other one is for backup when the first ring is disconnected because of a physical disorder or when a disorder occurs in the nodes constituting the ring. Like the token ring system, the FDDI employs the token facing method, causing a deterioration of data transmission efficiency.

Another system using the ring protocol is SONET/SDH (Synchronous Optical Network/Synchronous Digital Hierarchy).

The SONET/SDH is a circuit-switched network system based on TDM (Time-Division Multiplexing) that uses two rings, one of which is activated for data transmission and the other is in a stand-by mode against a disorder as in the FDDI system.

Hence, the actually available ring bandwidth of SONET/SDH is no more than 50%, and the other 50% is preserved for recovery from disorders.

Like FDDI and SONET/SDH, RPR (Resilient Packer Ring) is comprised of two rings.

In RPR, the two rings are operated in a diametrically opposed direction, and, contrary to the case of FDDI, both of them are used for data transmission simultaneously.

FIG. 1 is a schematic block diagram of a bi-directional ring network having a spatial reuse protocol of bandwidth.

Referring to FIG. 1, the bi-directional ring network having a spatial bandwidth reuse protocol has a plurality of nodes 1 to 6 101 to 106 connected in two rings, i.e., outer ring 111 and inner ring 112, which are both capable of simultaneous data transmission.

The bi-directional ring network is operated by a destination-release mechanism that uses the two rings and eliminates the frame at the destination.

For data transmission from node 1 101 to node 3 103, the path from node 3 103 to node 6 106 is not used, but rather the transmission path of the inner ring 112 is used. All the nodes on the path are available for data transmission and reception, thereby drastically increasing the bandwidth in the whole network.

FIG. 2 is a block diagram of a MAC (Media Access Control) structure supporting the bi-directional ring network according to prior art.

Referring to FIG. 2, the MAC structure in the dual ring network comprises a MAC client 201, a MAC controller 202, a MAC data section 203, a ring 0 204, a ring 1 205, a PHY 0 206, and a PHY 1 207.

In this structure, the MAC data section 203 transmits data (1) received from the MAC client 201 through either ring. The path for data transmission is determined according to a control signal (2) of the MAC controller 202.

Each node on the ring network has the same MAC structure, and the data transferred from another node are fed into the corresponding MAC data section 203 with reference to a ring number included in the data.

FIG. 3 is a block diagram of a packet format applied in the ring network according to prior art.

The packet format in the conventional dual ring network is one of standardization. FIG. 3 presents the packet format of SRP (Spatial Reuse Protocol).

Referring to FIG. 3, the packet of the ring network includes a header for a dual ring (i.e., RPR header) 310 attached to the existing Ethernet frame, and the contents of the header are TTL (Time To Live) 302 and RI (Ring ID; ring number) 311. The TTL 302 is used for preventing an unlimited repetition of packets, and the RI 311 is for selecting a corresponding ring in packet transmission.

In packet reception, the header of the packet is checked to determine whether or not the RI is matched, and unmatched packets are not received. In packet transmission, the number of a corresponding ring is necessarily written in the RI according to policy.

FIG. 4 is a flow chart of a ring selection method according to prior art.

Referring to FIG. 4, for selecting a ring between reception node 410 and transmission node 420, the dual ring network is initialized and then every node on the ring transmits a topology packet.

The topology information of each node is added to the topology packet one by one, as the packet makes a round of the ring. Hence, the topology packet gets a topology map from each node that specifies the node s MAC address, port number, inter-node hop number, and so forth.

In a packet transmission from one node to another with the topology map constructed, the transmission node 420 sends an ARP (Address Resolution Protocol) request message to the reception node 410 to get information on the MAC address of the reception node 410, in step S401. Here, the ARP request message is broadcast to every node.

With the broadcast ARP request message, the reception node 410 selects a ring having the least hop number with reference to the topology map according to the ARP request message, and sends an ARP response to the transmission node 420, in step S402.

If the selected ring is the one opposite to the ring for receiving the ARP response, i.e., the outer ring 111, then the transmission node 420 receiving the ARP response adds the value of the inner ring 112 in the routing table to update the routing table.

The transmission node 420 transmits the packet with reference to the routing table, in step S403.

The reason of selecting the ring opposite to the receiving ring in the above procedure is because the ring opposite to the ring for receiving the ARP response is the shortest path having the least hop number in the actual data transmission.

However, the above-stated method according to prior art solely considers the inter-node hop number in selecting a ring with reference to the routing table for selection of the RI of the packet header in generation of packets, thereby not making the best use of bandwidth, and it transmits an excessively large amount of packets impulsively on the same ring to cause congestion and hence a convergence of packets on the specific ring.

### SUMMARY OF THE INVENTION

It is an advantage of the present invention to provide a ring selection method for dual ring networks that selects a ring in consideration of a bandwidth allocation status given to each node to prevent a convergence of packets on a specific ring, and decentralizes the use frequency of the rings, thereby making the best use of the bandwidth of the rings.

In one aspect of the present invention, there is provided a ring selection method for a dual ring network, said method for node-to-node packet transmission of the dual ring network including a plurality of nodes, the ring selection method including: (a) a transmission node transmitting a reception node address request message for packet transmission to all the nodes, and updating a routing table using information on a short path transferred from the reception node; (b) the transmission node using information on inter-node hop numbers included in the routing table, and selecting a ring having the lowest hop number between the reception nodes; (c) the transmission node determining whether or not the selected ring is wrapped, and if the selected ring is not wrapped, comparing its usage rate and the hop number to the reception node with reference values based on a ring selection algorithm; and (d) if the selected ring is suitable for the reference values, the transmission node selecting the ring for packet transmission.

Preferably, in (a), all the nodes including transmission and reception nodes have a topology map through a topology packet change at the time od system initialization, the topology map including information on inter-node hop numbers, port information, MAC address, and wrapped-or-not information.

Preferably, the ring selection algorithm of (c) includes: the transmission node calculating a transmission coefficient using the hop number and delay time based on a path between the reception nodes, and the inter-node usage rate, storing the calculated transmission coefficient in the routing table, and selecting a ring having a lower transmission coefficient stored in the routing table as the reference value.

Preferably, the comparison with the reference values in (c) includes: determining whether or not the selected ring and the ring selected by the ring selection algorithm are matched to the reference values.

Preferably, the transmission coefficient is determined with reference to the hop number between the transmission node and the reception node, the usage rate of each node, and the inter-node delay time.

Preferably, the usage rate and the transmission coefficient are calculated in a predetermined cycle, and updated in the routing table of each node.

Preferably, (c) includes: selecting the other ring when the selected ring is wrapped.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic block diagram of a bi-directional ring network having a spatial bandwidth reuse protocol;

FIG. 2 is a block diagram of a MAC (Media Access Control) structure supporting the bi-directional ring network according to prior art;

FIG. 3 is a block diagram of a packet format applied in the ring network according to prior art;

FIG. 4 is a flow chart of a ring selection method according to prior art;

FIG. 5 is a flow chart of a ring selection method for dual ring networks according to an embodiment of the present invention;

FIG. 6 is a block diagram of a ring selection structure in the ring selection method for dual ring networks according to the embodiment of the present invention; and

FIG. 7 is a diagram showing a routing table construction in the ring selection method for dual ring networks according to the embodiment of the present invention.

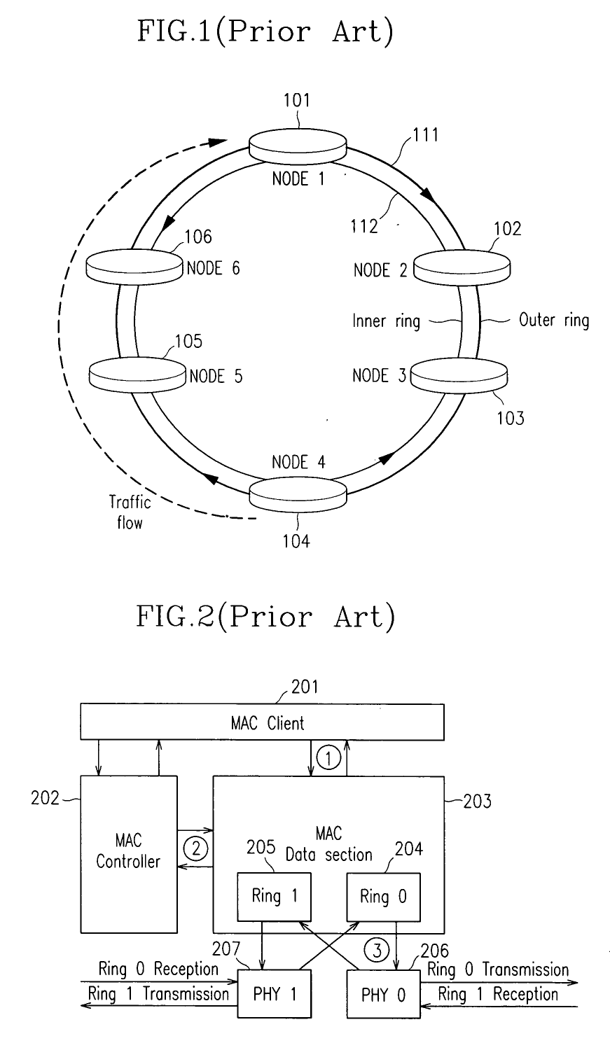

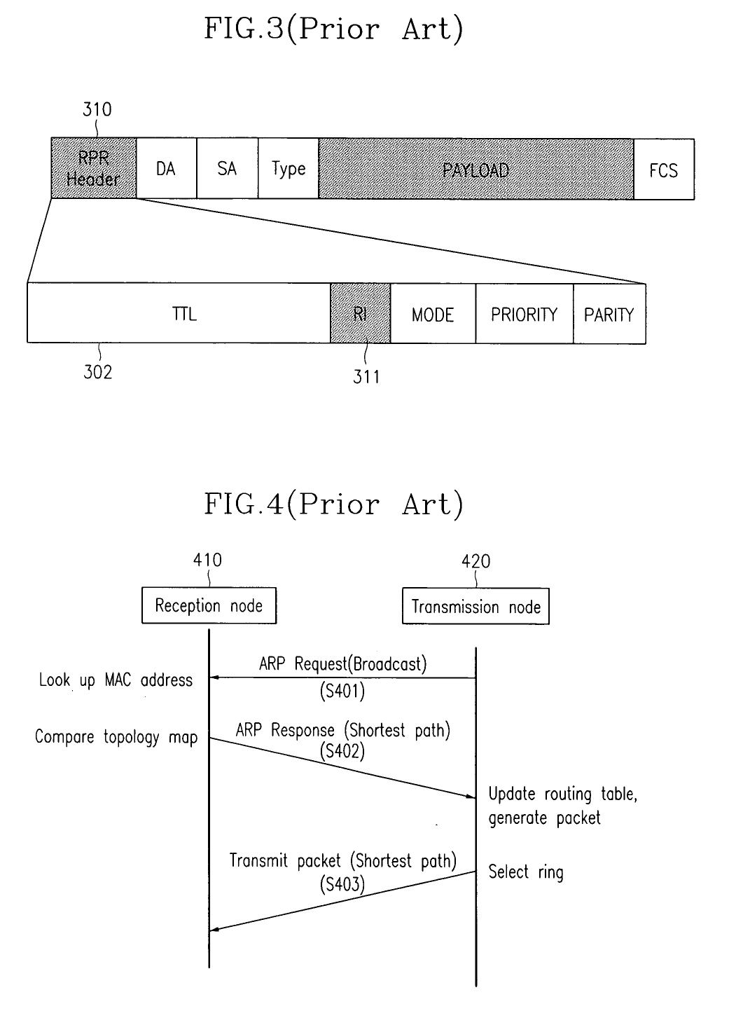

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

FIG. 5 is a flow chart of a ring selection method for dual ring networks according to an embodiment of the present invention.

Referring to FIG. 5, every node connected to the dual ring network has a topology map through a topology packet change.

The topology map includes contents on inter-node hop numbers, port information, MAC address, and wrapped-or-not information.

Once all the nodes have the topology map, a transmission node 520 broadcasts an ARP request message to every node to get information on the MAC address of a reception node 510, in step 501.

Upon receiving the ARP request message, the reception node 510 checks the MAC address, in step 502, makes sure that the MAC address in the ARP request message is its address, and compares its own topology maps, in step 503. Then the reception node 510 selects a ring having the lowest hop number and sends an ARP response message to the transmission node 520, in step 504.

Upon receiving the ARP response message, the transmission node 520 updates the routing table and runs a fairness algorithm for bandwidth allocation to calculate the node-based allocated bandwidth in the unit of usage rate, in step 505.

The usage rate represents the maximum bandwidth available to the corresponding node, and it has a control function of preventing data transmission with a bandwidth exceeding the maximum bandwidth.

In data transmission on the ring network, the transmission node 520 adds a MAC header for the dual ring network to the data, and at the same time, runs a ring selection algorithm for selecting a ring and determining a ring number, in step 506.

The ring selection algorithm is a method of selecting either of the two rings for data transmission so as to use the bandwidth effectively. This is the key algorithm of the present invention.

First, the ring selection algorithm will be described in detail.

The dual ring network has two paths for packet transmission from one node to another. Upon a host generating a packet, the ring selection algorithm checks the MAC address of the packet destination and preliminarily selects a ring.

In the ring selection step, the ring selection algorithm selects a ring having a lower hop number with reference to the routing table updated in the step 505.

Here, the routing table is used to match the IP address to the MAC address through ARP request and ARP response, through which methods the routing table is maintained in a completed form.

Subsequently, the selected ring is checked in regard to the topology status to determine whether or not the ring is wrapped. If the ring is wrapped, then the other ring is selected.

If the ring is not wrapped and it is in a normal state, then the ring selection algorithm is used to compare the usage rate of the corresponding node and the hop number from the node to the destination node with reference values.

The packet is transmitted on the selected ring if the topology status of the ring meets the reference values according to the ring selection algorithm, and otherwise, the other ring is selected because the dissatisfaction with the reference values means that the first selected ring cannot be used with a bandwidth exceeding the reference value.

In the embodiment of the present invention, the ring selection algorithm is realized using the transmission coefficient given by the following equation:
transmission coefficient=hop number×(100 Mbit/usage rate)+delay time per node Equation 1

Prior to packet transmission, the transmission coefficients of the two rings are calculated according to the above equation, and then compared with each other so that a ring having a lower transmission coefficient is chosen.

Once the ring is selected using the ring selection algorithm, the packet is generated, in step 507, and the ring number of the selected ring is determined, in step 508. Then the packet is transmitted to the reception node 510 on the selected ring, in step 509.

Now, a description will be given as to an embodiment of the above-stated method of FIG. 5.

FIG. 6 is a block diagram of a ring selection structure in the ring selection method for dual ring networks according to the embodiment of the present invention.

Referring to FIG. 6, when an algorithm included in the transmission coefficient is used as the ring selection algorithm, the transmission coefficient in packet transmission from node 1 101 to node 4 104 is determined on the basis of the required time for 100 Mbit data transmission, and it is calculated in consideration of the inter-node hop number, usage rate, and delay time per node.

The term usage rate as used herein refers to an allowable transmission rate per node according to a fairness algorithm. The unit of the usage rate is Mbps. The term delay time per node as used herein refers to a delay time for processing the packet at the node. The delay time per node is determined according to a node-designing method and a packet-processing method, and it is variable depending on the environment.

The transmission coefficient can be calculated according to Equation 1.

In FIG. 6, the usage rate is 100 Mbps for ring 1 610 and 50 Mbps for ring 2 620, and the transmission coefficient is 6 for outer ring 620 and 5 for inner ring 610.

Hence, the node 1 101 transmits the packet to the node 4 104 on the inner ring 610. This can be described in comparison with the packet transmission from node 1 101 to node 4 104 on the outer ring in the prior art.

Now, a description will be given as to the routing table based on the ring number for packet transmission according to node-based hop number, usage rate, and transmission coefficient in the dual ring network shown in FIG. 6.

FIG. 7 is a diagram showing a routing table construction in the ring selection method for dual ring networks according to the embodiment of the present invention.

In FIG. 7, the routing table of node 1 101 according to the structure of FIG. 6 is illustrated by way of a comparison of the prior art (a) and the embodiment of the present invention (b). The prior art routing table (a) of node 1 presents the inter-node hop number and the hop number-based ring number, which are predetermined.

Contrarily, the routing table (b) according to the embodiment of the present invention includes information on the usage rates of the two rings and the transmission coefficients for the individual nodes based on the usage rates, so that the ring number finally considered in data transmission is given to select a ring having a lower transmission coefficient.

As illustrated in FIG. 7, the embodiment of the present invention uses the inner ring 610 for packet transmission from node 1 101 to node 4 104, while the prior art uses the outer ring 620.

As described above, the ring selection method for dual ring networks according to the present invention considers the allowable usage rate and delay time of the individual nodes as well as inter-node hop number in selecting a ring, enabling a more efficient path selection, and when congestion occurs at a specific node, it transmits packets through an alternative path determined by a ring selection algorithm instead of lowering the usage rate until the congestion is relieved, thereby enhancing transmission speed and making the best use of the whole ring.

Furthermore, the present invention also considers the usage rate determined by a conventional bandwidth selection algorithm, thus eliminating a need for additional functions and enhancing data transmission efficiency.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A ring selection method for node-to-node packet transmission in a dual ring network including a plurality of transmission nodes and reception nodes, said method comprising:
(a) transmitting a reception node address request message for packet transmission to all the nodes, and updating a routing table using information on a short path transferred from the reception node;
(b) using information on inter-node hop numbers included in the routing table to select a ring having the lowest hop number between the reception nodes;
(c) determining whether or not the selected ring is wrapped, and
if the selected ring is not wrapped, comparing its usage rate and hop number with reference values based on a ring selection algorithm; and
(d) if the selected ring is suitable for packet transmission based on the reference values, selecting the ring for packet transmission.

2. The ring selection method as claimed in claim 1, wherein in (a), each of the transmission and reception nodes have a topology map including information on inter-node hop numbers, port information, MAC address, and wrapped-or-not information.

3. The ring selection method as claimed in claim 1, wherein the ring selection algorithm of (c) comprises:
calculating a transmission coefficient using the hop number and delay time based on a path between the reception nodes, and the inter-node usage rate, storing the calculated transmission coefficient in the routing table, and selecting a ring having a lower transmission coefficient stored in the routing table as the reference value.

4. The ring selection method as claimed in claim 1, wherein the comparison with the reference values in (c) comprises:
determining whether or not the selected ring and the ring selected by the ring selection algorithm are matched to the reference values.

5. The ring selection method as claimed in claim 3, wherein the transmission coefficient is determined with reference to the hop number between the transmission node and the reception node, the usage rate of each node, and the inter-node delay time.

6. The ring selection method as claimed in claim 3, wherein the usage rate and the transmission coefficient are calculated in a predetermined cycle, and updated in the routing table.

7. The ring selection method as claimed in claim 1, further comprising:
selecting the other ring when the selected ring is wrapped.

8. A method for selecting a ring for transmitting packets in a dual ring network comprising:
if neither ring is wrapped:
a) calculating a transmission coefficient for each ring based on for each node in each ring, a hop number, a usage rate and a delay time;
b) selecting the ring with the lowest calculated transmission coefficient for transmitting packets.

9. The method defined by claim 8 wherein said hop number and said usage rate are determined with reference to values in a routing table.

10. The method defined by claim 8, wherein each of the nodes has a topology map including information on inter-node hop numbers, port information, MAC address, and wrapped-or-not information.

11. The method defined by claim 8, wherein said selecting comprises:
calculating a transmission coefficient for each of the nodes, storing the calculated transmission coefficient in a routing table, and selecting a ring having a lowest transmission coefficient stored in the routing table.

12. The method defined by claim 8, wherein the usage rate and the transmission coefficient are calculated in a predetermined cycle, and updated in the routing table.
